(19) United States
(12) Patent Application Publication
(10) Pub. No.: US 2021/0209311 A1
(43) Pub. Date: Jul. 8, 2021

(54) SENTENCE DISTANCE MAPPING METHOD AND APPARATUS BASED ON MACHINE LEARNING AND COMPUTER DEVICE

(71) Applicant: PING AN TECHNOLOGY (SHENZHEN) CO., LTD., Shenzhen, Guangdong (CN)

(72) Inventors: Yuchao Liu, Shenzhen, Guangdong (CN); Dian Guo, Shenzhen, Guangdong (CN); Ling Han, Shenzhen, Guangdong (CN)

(21) Appl. No.: 16/759,368

(22) PCT Filed: May 29, 2019
(86) PCT No.: PCT/CN2019/089059

§ 371 Date: Apr. 27, 2020

(30) Foreign Application Priority Data
Nov. 28, 2018 (CN) 201811437243.6

(51) Int. Cl. G06F 40/35; G06F 40/237

(52) U.S. Cl. CPC G06F 40/35; G06F 40/237

(57) ABSTRACT

A sentence distance mapping method and apparatus based on machine learning, a computer device, and a storage medium are described herein. The method includes: acquiring input single-sentence speech information; converting the single-sentence speech information into single-sentence text information; preprocessing the single-sentence text information, and querying a preset word vector library to obtain a word vector corresponding to each word in the preprocessed single-sentence text information; calculating a distance between the single-sentence text information and a preset standard single sentence by using a preset algorithm based on the word vector corresponding to each word in the single-sentence text information; and inputting the distance into a preset function and obtaining a score through mapping, where the preset function is obtained by performing training on training data.

The present application claims priority to Chinese Patent Application No. 201811437243.6, filed with the National Intellectual Property Administration, PRC on Nov. 28, 2018, and entitled “SENTENCE DISTANCE MAPPING METHOD AND APPARATUS BASED ON MACHINE LEARNING AND COMPUTER DEVICE”, which is incorporated herein by reference in its entirety.

### TECHNICAL FIELD

The present disclosure relates to the computer field, and in particular, to a sentence distance mapping method and apparatus based on machine learning, a computer device, and a storage medium.

### BACKGROUND

The statements in this section merely provide background information related to the present disclosure and do not necessarily constitute prior art.

In the field of natural language processing, sentence similarity calculation is one of important content (namely, calculating the similarity between two sentences). In particular, the sentence similarity calculation is applied more and more frequently in application fields such as information retrieval, question-answering systems, and machine translation. Cosine similarity could be used to calculate the similarity between two sentences. This method generally collects statistics about the frequency of the same word between two sentences to form a word frequency vector, and then uses the word frequency vector to calculate the similarity between the two sentences.

### SUMMARY

A sentence distance mapping method based on machine learning, including the following steps:

acquiring input single-sentence speech information;

converting the single-sentence speech information into single-sentence text information;

preprocessing the single-sentence text information, and querying a preset word vector library to obtain a word vector corresponding to each word in the preprocessed single-sentence text information, where the preprocessing includes at least word segmentation processing;

calculating a distance between the single-sentence text information and a preset standard single sentence by using a preset algorithm based on the word vector corresponding to each word in the single-sentence text information, where the preset standard single sentence undergoes at least word segmentation processing; and

inputting the distance into a preset function to obtain a score through mapping, where the preset function is obtained by performing training on training data, and the training data includes a training single sentence, a standard training single sentence, a distance between the training single sentence and the standard training single sentence, and a manual score on a similarity between the training single sentence and the standard training single sentence.

A sentence distance mapping apparatus based on machine learning, including:

a single-sentence speech information acquisition unit, configured to acquire input single-sentence speech information;

a single-sentence text information conversion unit, configured to convert the single-sentence speech information into single-sentence text information;

a preprocessing unit, configured to preprocess the single-sentence text information, and query a preset word vector library to obtain a word vector corresponding to each word in the preprocessed single-sentence text information, where the preprocessing includes at least word segmentation processing;

a sentence distance calculation unit, configured to calculate a distance between the single-sentence text information and a preset standard single sentence by using a preset algorithm based on the word vector corresponding to each word in the single-sentence text information, where the preset standard single sentence undergoes at least word segmentation processing; and

a score mapping unit, configured to input the distance into a preset function to obtain a score through mapping, where the preset function is obtained by performing training on training data, and the training data includes a training single sentence, a standard training single sentence, a distance between the training single sentence and the standard training single sentence, and a manual score on a similarity between the training single sentence and the standard training single sentence.

A computer device, including a memory and a processor, where the memory stores computer readable instructions, and steps of the method according to any one of the foregoing items are implemented when the processor executes the computer readable instructions.

A non-volatile computer readable storage medium storing computer readable instructions, where steps of the method according to any one of the foregoing items are implemented when the computer readable instructions are executed by a processor.

### BRIEF DESCRIPTION OF DRAWINGS

FIG. 1 is a schematic flow chart of a sentence distance mapping method based on machine learning according to some embodiments;

FIG. 2 is a schematic structural block diagram of a sentence distance mapping apparatus based on machine learning according to some embodiments; and

FIG. 3 is a schematic structural block diagram of a computer device according to some embodiments.

### DETAILED DESCRIPTION

To make the objective, technical solutions and advantages of the present disclosure clearer and more comprehensible, the following further describes the present disclosure in detail with reference to the accompanying drawings and embodiments. It should be understood that the specific embodiments described herein are merely illustrative of the present disclosure and are not intended to limit the present disclosure.

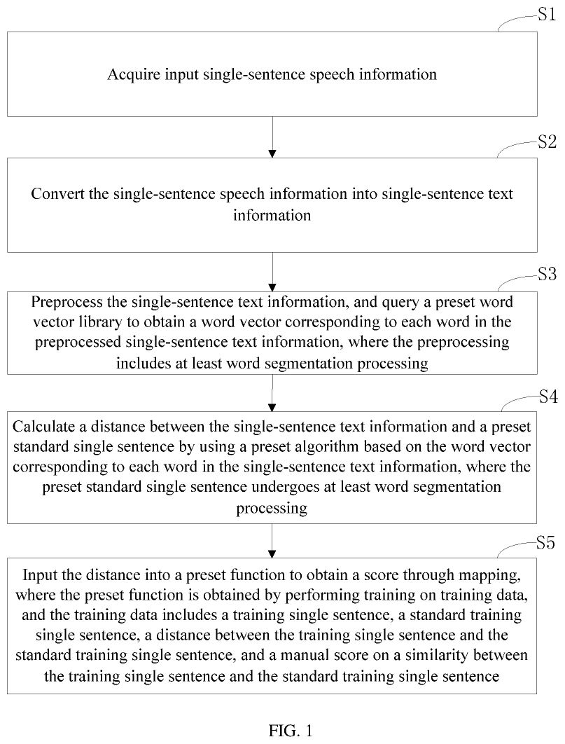

Referring to FIG. 1, some embodiments provides a sentence distance mapping method based on machine learning, including the following steps.

S1: Acquire input single-sentence speech information.

S2: Convert the single-sentence speech information into single-sentence text information.

S3: Preprocess the single-sentence text information, and query a preset word vector library to obtain a word vector corresponding to each word in the preprocessed single-sentence text information, where the preprocessing includes at least word segmentation processing.

S4: Calculate a distance between the single-sentence text information and a preset standard single sentence by using a preset algorithm based on the word vector corresponding to each word in the single-sentence text information, where the preset standard single sentence undergoes at least word segmentation processing.

S5: Input the distance into a preset function to obtain a score through mapping, where the preset function is obtained by performing training on training data, and the training data includes a training single sentence, a standard training single sentence, a distance between the training single sentence and the standard training single sentence, and a manual score on a similarity between the training single sentence and the standard training single sentence.

As described in step S1, input single-sentence speech information is acquired. Some embodiments can be used in scenarios such as verbal trick learning, lecture trials, and simulated insurance sales. Therefore, it is necessary to first obtain single-sentence speech information input by the user. Methods of obtaining include: obtaining speech information by using a microphone; obtaining speech information by using a microphone array; and the like. In at least one embodiment, the obtained speech information is a single sentence.

As described in step S2, the single-sentence speech information is converted into single-sentence text information. A method of speech conversion may be any feasible method, and the single-sentence speech information can be converted into single-sentence text information by using any mature software available in the market.

As described in S3, the single-sentence text information is preprocessed, and a preset word vector library is queried to obtain a word vector corresponding to each word in the preprocessed single-sentence text information, where the preprocessing includes at least word segmentation processing. Therefore, the single sentence is divided into a plurality of words. The preprocessing includes word segmentation, word segmentation correction, synonym replacement, removal of stop words, and the like. The word segmentation can be performed by using open-source word segmentation tools such as jieba, SnowNLP, THULAC, and NLPIR. Word segmentation methods include: a word segmentation method based on string matching, a word segmentation method based on understanding, and a word segmentation method based on statistics.

As described in S4, a distance between the single-sentence text information and a preset standard single sentence is calculated by using a preset algorithm based on the word vector corresponding to each word in the single-sentence text information. A method for calculating a distance between the single-sentence text information and a preset standard single sentence by using a preset algorithm includes: using a Word Mover's Distance (WMD) algorithm, a simhash algorithm, and a cosine similarity-based algorithm to calculate a distance between the single-sentence text information and a preset standard single sentence.

As described in S5, the distance is input into a preset function, and a score is mapped out, where the preset function is obtained by performing training on training data, and the training data includes a training single sentence, a standard training single sentence, a distance between the training single sentence and the standard training single sentence, and a manual score on a similarity between the training single sentence and the standard training single sentence. The preset function is obtained through machine learning, so the score mapped out by the preset function is more accurate. The preset function is intended to map the distance between the single-sentence text information and the preset standard single sentence into a score, so that a user can visually know the similarity between the single-sentence text information and the preset standard single sentence. In at least one embodiment, the score is a centesimal system. In at least one embodiment, the preset function is a unary quadratic function.

In some embodiments, the step S3 of preprocessing the single-sentence text information includes the following steps.

S301: Perform word segmentation on the single-sentence text information to obtain a word sequence containing a plurality of words.

S302: Determine whether a synonym group exists in the word sequence by querying a preset synonym library.

S303: If a synonym group exists, replace all words in the synonym group with any one in the synonym group.

As described in steps S301-S303, preprocessing of the single-sentence text information is implemented. The word segmentation can be performed by using open-source word segmentation tools such as jieba, SnowNLP, THULAC, and NLPIR. Word segmentation methods include: a word segmentation method based on string matching, a word segmentation method based on understanding, and a word segmentation method based on statistics. Therefore, the single sentence is divided into a plurality of words. For example, “Beijing feng jing hao, shi lv you sheng di”, can be divided into “|Beijinglfeng jinglhaolshillv youlsheng di|”. In order to reduce the amount of calculation, and to increase the accuracy of the meaning of words, by querying a preset synonym library, whether a synonym group exists in the word sequence is determined, and if a synonym group exists, all words in the synonym group are replaced with any one in the synonym group. Specifically, the synonym library includes a plurality of synonym entries, and if two or more words appear in the same synonym entry in the word sequence, it indicates that the two or more words constitute a synonym group. In general, the replacement of synonyms does not lead to changes in the original meaning of a single sentence, so a synonym replacement mode is adopted to reduce a calculated amount and data storage. Whether a synonym group exists in the word sequence can be determined by querying a preset synonym library.

In some embodiments, the step S4 of calculating a distance between the single-sentence text information and a preset standard single sentence by using a preset algorithm based on the word vector corresponding to each word in the single-sentence text information includes the following steps.

S401: Adopt the following formula:

$$Distance ( I , R ) = \frac{{\sum }_{w ∈ I} min ( max ( α \times cos Dis ( w , R ) ) , I )}{\vert I \vert + \vert R \vert} + \frac{{\sum }_{w ∈ R} min ( max ( α \times cos Dis ( w , R ) ) , I )}{\vert I \vert + \vert R \vert}$$

to calculate the distance between the single-sentence text information and the preset standard single sentence, where Distance(I,R) denotes a distance between a single sentence I and a single sentence R; I denotes the single-sentence text information; R denotes the preset standard single sentence; |I| denotes the number of words with word vectors in the single-sentence text information; |R| denotes the number of words with word vectors in the preset standard single sentence; w denotes a word vector; α denotes an amplification coefficient for adjusting a cosine similarity between two word vectors; and max(α×Cos Dis(w,R)) denotes a calculated maximum value among cosine similarities between word vectors corresponding to all words in the single sentence R and the word vector w in the single sentence I.

As described in S401, a distance between the single-sentence text information and a preset standard single sentence is calculated by using a preset algorithm. The foregoing formula takes advantage of a cosine similarity of word vectors. A formula for calculating the cosine similarity is:

$$CosDis ( {w}_{1} , {w}_{2} ) = \frac{{w}_{1} \cdot {w}_{2}}{‖ {w}_{1} ‖ \times ‖ {w}_{2} ‖} = \frac{{\sum }_{i = 1}^{n} {w}_{1 i} \times {w}_{2 i}}{\sqrt{{\sum }_{i = 1}^{n} {( {w}_{1 i} )}^{2} \times \sqrt{{\sum }_{i = 1}^{n} {( {w}_{2 i} )}^{2}}}} ,$$

where w1 denotes the first word vector (the word vector of each word in the single-sentence text information); w2 denotes the second word vector (the word vector of each word in the preset standard sentence); n denotes a dimension of a word vector, and thus the similarity between the word vectors w1 and w2 is calculated. By substituting the cosine similarity calculation formula into the formula for calculating the distance between the single-sentence text information and the preset standard single sentence, the distance between the single-sentence text information and the preset standard single sentence can be calculated.

In some embodiments, the step S4 of calculating a distance between the single-sentence text information and a preset standard single sentence by using a preset algorithm based on the word vector corresponding to each word in the single-sentence text information includes the following steps.

S402: Adopt the following formula:

$$Distance ( I , R ) = {min}_{T \geq 0} {\sum }_{i = 1}^{m} {\sum }_{j = 1}^{m} {T}_{i j} c ( i , j ) , where {\sum }_{i = 1}^{m} {T}_{i j} = {d}_{j}^{′} ∀ j ∈ \{ 1 , … , n \} , {\sum }_{j = 1}^{n} {T}_{i j} = {d}_{i} ∀ i ∈ \{ 1 , … , m \}$$

to calculate the distance between the single-sentence text information and the preset standard single sentence; where Distance(I,R) denotes a distance between a single sentence I and a single sentence R; I denotes the single-sentence text information; R denotes the preset standard single sentence; Tij denotes an amount of weight transfer from an i-th word in the single sentence I to a j-th word in the single sentence R; di denotes a frequency of the i-th word in the single sentence I; d′ⱼ denotes a frequency of the j-th word in the single sentence R; c(i,j) denotes an Euclidean distance between the i-th word in the single sentence I and the j-th word in the single sentence R; m denotes the number of words with word vectors in the single sentence I; and n denotes the number of words with word vectors in the single sentence R.

As described in S402, a distance between the single-sentence text information and a preset standard single sentence is calculated by using a preset algorithm. The foregoing formula takes advantage of an Euclidean distance of word vectors. A formula for calculating the Euclidean distance is:

$$d ( x , y ) := \sqrt{{( {x}_{1} - {y}_{1} )}^{2} + {( {x}_{2} - {y}_{2} )}^{2} + … + {( {x}_{n} - {y}_{n} )}^{2}} = \sqrt{{\sum }_{i = 1}^{n} {( {x}_{i} - {y}_{i} )}^{2} .} ,$$

where d(x,y) denotes an Euclidean distance between a word vector x=(x1, x2, x3 . . . , xn) and a word vector y=(y1, y2, y3 . . . , yn), and n denotes a dimension of a word vector. By substituting the Euclidean distance calculation formula into the formula for calculating the distance between the single-sentence text information and the preset standard single sentence, the distance between the single-sentence text information and the preset standard single sentence can be calculated.

In some embodiments, the preset function is a unary quadratic function, and the step of obtaining the preset function by performing training on training data includes:

S501: Establish a unary quadratic function f(x)=ax²+bx+c, where x is an independent variable representing a sentence distance, and f(x) is a dependent variable representing a mapping score.

S502: Obtain n pieces of sample data, and randomly divide the sample data into n/3 groups, where each group has three pieces of sample data, the sample data includes a training distance between a training single sentence and a standard single sentence and a manual score result corresponding to the training distance, and n is a multiple of 3.

S503: Assign the n/3 groups of data into the unary quadratic function to obtain values of n/3 groups of coefficients a, b, and c.

S504: Perform a mean calculation on the values of the n/3 groups of coefficients a, b, and c to obtain final values of the coefficients a, b, and c.

As described in steps S501-S504, the preset function is obtained by training the training data. The manual score refers to scoring the similarity between the training single sentence and the standard single sentence by means of human feeling to reflect the similarity between the training single sentence and the standard single sentence. The score may adopt a centesimal system, that is, the score of 100 means complete similarity, and the score of 0 means complete dissimilarity. Since the unary quadratic function has three coefficients a, b, and c, exact coefficient values can be obtained by using three samples, so sample data is divided into n/3 groups, so that under the premise of a certain calculated amount, non-repetitive n/3 group coefficient values are obtained. In order to obtain more accurate results, the n/3 groups of coefficients are performed a mean calculation to obtain the final values of the coefficients a, b, and c. The mean calculation includes: arithmetic average calculation, geometric average calculation, root mean square averaging calculation, weighted average calculation, and the like.

In some embodiments, the preset word vector library is obtained through training by using a word vector generating tool word2vec, and the training method includes the following steps.

S311: Perform word vector training on words in a preset corpus by using a Continuous Bag-of-Words (CBOW) model of the tool word2vec to obtain the preset word vector library, where the corpus is a word library for training word vectors.

As described in the foregoing step, the preset word vector library is acquired. Word2vec is a tool for training word vectors, including a CBOW model and a Skip-Gram model. The CBOW is to infer a target word from an original sentence; and Skip-Gram is to infer an original sentence from a target word. The CBOW is more suitable for a small word corpus, and in some embodiments, the CBOW model is selected for word vector training.

In some embodiments, before the step S4 of calculating a distance between the single-sentence text information and a preset standard single sentence by using a preset algorithm based on the word vector corresponding to each word in the single-sentence text information, the method includes the following steps.

S31: Calculate a similarity between the single-sentence text information and all standard single sentences in a standard single sentence library by using a reduplicative word similarity algorithm.

S32: Determine whether a standard single sentence having a similarity greater than a first threshold exists.

S33: Set, if a standard single sentence having a similarity greater than the first threshold exists, the standard single sentence having the similarity greater than the first threshold as the preset standard single sentence.

As described in steps S31-S33, the preset standard single sentence is determined. The reduplicative word similarity algorithm is calculated in accordance with the cosine similarity between two sentences to reflect the similarity between the two sentences. Since the reduplicative word similarity algorithm uses only reduplicative words to determine accuracy, the determining of similarity between sentences is not accurate enough, but the reduplicative word similarity algorithm can be used to screen standard single sentences. The similarity algorithm is:

$$s imilarity = cos ( θ ) = \frac{A \cdot B}{‖ A ‖ ‖ B ‖} = \frac{{\sum }_{i = 1}^{n} {A}_{i} {B}_{i}}{\sqrt{{\sum }_{i = 1}^{n} {A}_{i}^{2}} \sqrt{{\sum }_{i = 1}^{n} {B}_{i}^{2}}}$$

where A denotes a word frequency vector of the single-sentence text information, B denotes a word frequency vector of a standard single sentence, and Ai denotes the number of times an i-th word of the single-sentence text information appears in the entire single sentence. On this basis, the similarity between two single sentences can be roughly obtained. If the similarity is greater than the first threshold, the two single sentences may be considered to be similar, and may be set as preset standard single sentences. The first threshold may be set based on actual needs, for example, set to any value of [80%-98%].

According to the sentence distance mapping method based on machine learning provided by some embodiments, acquired single-sentence speech information is converted into single-sentence text information, a word vector corresponding to each word in the preprocessed single-sentence text information is acquired by preprocessing, a distance between the single-sentence text information and a preset standard single sentence is calculated by using a preset algorithm by means of the word vector, and the distance is input into a preset function to obtain a score through mapping, which has more accurate and more visual technical effects.

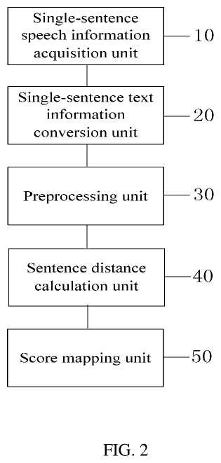

Referring to FIG. 2, some embodiments provide a sentence distance mapping apparatus based on machine learning, including:

a single-sentence speech information acquisition unit 10, configured to acquire input single-sentence speech information;

a single-sentence text information conversion unit 20, configured to convert the single-sentence speech information into single-sentence text information;

a preprocessing unit 30, configured to preprocess the single-sentence text information, and query a preset word vector library to obtain a word vector corresponding to each word in the preprocessed single-sentence text information, where the preprocessing includes at least word segmentation processing;

a sentence distance calculation unit 40, configured to calculate a distance between the single-sentence text information and a preset standard single sentence by using a preset algorithm based on the word vector corresponding to each word in the single-sentence text information, where the preset standard single sentence undergoes at least word segmentation processing; and

a score mapping unit 50, configured to input the distance into a preset function to obtain a score through mapping, where the preset function is obtained by performing training on training data, and the training data includes a training single sentence, a standard training single sentence, a distance between the training single sentence and the standard training single sentence, and a manual score on a similarity between the training single sentence and the standard training single sentence.

The operations respectively performed by the foregoing units are in one-to-one correspondence to the steps of the sentence distance mapping method based on machine learning of the foregoing embodiments respectively, and are not described herein again.

In some embodiments, the preprocessing unit 30 includes:

a word segmentation subunit, configured to perform word segmentation on the single-sentence text information to obtain a word sequence containing a plurality of words;

a synonym group determining subunit, configured to determine whether a synonym group exists in the word sequence by querying a preset synonym library; and

a synonym replacement subunit, configured to replace, if a synonym group exists, all words in the synonym group with any one in the synonym group.

The operations respectively performed by the foregoing subunits are in one-to-one correspondence to the steps of the sentence distance mapping method based on machine learning of the foregoing embodiments respectively, and are not described herein again.

In some embodiments, the sentence distance calculation unit 40 includes:

a first sentence distance calculation unit, configured to adopt the following formula:

$$Distance ( I , R ) = \frac{{\sum }_{w ∈ I} min ( max ( α \times cos Dis ( w , R ) ) , I )}{\vert I \vert + \vert R \vert} + \frac{{\sum }_{w ∈ R} min ( max ( α \times cos Dis ( w , R ) ) , I )}{\vert I \vert + \vert R \vert}$$

to calculate the distance between the single-sentence text information and the preset standard single sentence, where Distance(I,R) denotes a distance between a single sentence I and a single sentence R; I denotes the single-sentence text information; R denotes the preset standard single sentence; |I| denotes the number of words with word vectors in the single-sentence text information; |R| denotes the number of words with word vectors in the preset standard single sentence; w denotes a word vector; α denotes an amplification coefficient for adjusting a cosine similarity between two word vectors; and max(α×Cos Dis(w,R)) denotes a calculated maximum value among cosine similarities between word vectors corresponding to all words in the single sentence R and the word vector w in the single sentence I.

The operations respectively performed by the foregoing subunits are in one-to-one correspondence to the steps of the sentence distance mapping method based on machine learning of the foregoing embodiments respectively, and are not described herein again.

In some embodiments, the sentence distance calculation unit 40 includes:

a second sentence distance calculation unit, configured to adopt the following formula:

$$Distance ( I , R ) = {min}_{T \geq 0} {\sum }_{i = 1}^{m} {\sum }_{j = 1}^{m} {T}_{i j} c ( i , j ) , where {\sum }_{i = 1}^{m} {T}_{i j} = {d}_{j}^{′} ∀ j ∈ \{ 1 , … , n \} , {\sum }_{j = 1}^{n} {T}_{i j} = {d}_{i} ∀ i ∈ \{ 1 , … , m \}$$

to calculate the distance between the single-sentence text information and the preset standard single sentence; where Distance(I,R) denotes a distance between a single sentence I and a single sentence R; I denotes the single-sentence text information; R denotes the preset standard single sentence; Tij denotes an amount of weight transfer from an i-th word in the single sentence I to a j-th word in the single sentence R; di denotes a frequency of the i-th word in the single sentence I; d′ⱼ denotes a frequency of the j-th word in the single sentence R; c(i,j) denotes an Euclidean distance between the i-th word in the single sentence I and the j-th word in the single sentence R; m denotes the number of words with word vectors in the single sentence I; and n denotes the number of words with word vectors in the single sentence R.

The operations respectively performed by the foregoing subunits are in one-to-one correspondence to the steps of the sentence distance mapping method based on machine learning of the foregoing embodiments respectively, and are not described herein again.

In some embodiments, the preset function is a unary quadratic function, and the apparatus includes:

an equation establishment unit, configured to establish a unary quadratic function f(x)=ax²+bx+c, where x is an independent variable representing a sentence distance, and f(x) is a dependent variable representing a mapping score;

a sample data acquisition unit, configured to obtain n pieces of sample data, and randomly divide the sample data into n/3 groups, where each group has three pieces of sample data, the sample data includes a training distance between a training single sentence and a standard single sentence and a manual score result corresponding to the training distance, and n is a multiple of 3;

a data assignment unit, configured to assign the n/3 groups of data into the unary quadratic function to obtain values of n/3 groups of coefficients a, b, and c; and

a mean calculation unit, configured to perform a mean calculation on the values of the n/3 groups of coefficients a, b, and c to obtain final values of the coefficients a, b, and c.

The operations respectively performed by the foregoing units are in one-to-one correspondence to the steps of the sentence distance mapping method based on machine learning of the foregoing embodiments respectively, and are not described herein again.

In some embodiments, the preset word vector library is obtained through training by using a tool word2vec, and the apparatus includes:

a word vector training unit, configured to perform word vector training on words in a preset corpus by using a CBOW model of the tool word2vec to obtain the preset word vector library, where the corpus is a word library for training word vectors.

The operations respectively performed by the foregoing units are in one-to-one correspondence to the steps of the sentence distance mapping method based on machine learning of the foregoing embodiments respectively, and are not described herein again.

In some embodiments, the apparatus includes:

a reduplicative word similarity algorithm calculation unit, configured to calculate a similarity between the single-sentence text information and all standard single sentences in a standard single sentence library by using a reduplicative word similarity algorithm;

a standard single sentence determining unit, configured to determine whether a standard single sentence having a similarity greater than a first threshold exists; and

a standard single sentence setting unit, configured to set, if a standard single sentence having a similarity greater than the first threshold exists, the standard single sentence having the similarity greater than the first threshold as the preset standard single sentence.

The operations respectively performed by the foregoing units are in one-to-one correspondence to the steps of the sentence distance mapping method based on machine learning of the foregoing embodiments respectively, and are not described herein again.

According to the sentence distance mapping apparatus based on machine learning provided by some embodiments, acquired single-sentence speech information is converted into single-sentence text information, a word vector corresponding to each word in the preprocessed single-sentence text information is acquired by preprocessing, a distance between the single-sentence text information and a preset standard single sentence is calculated by using a preset algorithm by means of the word vector, and the distance is input into a preset function to obtain a score through mapping, which has more accurate and more visual technical effects.

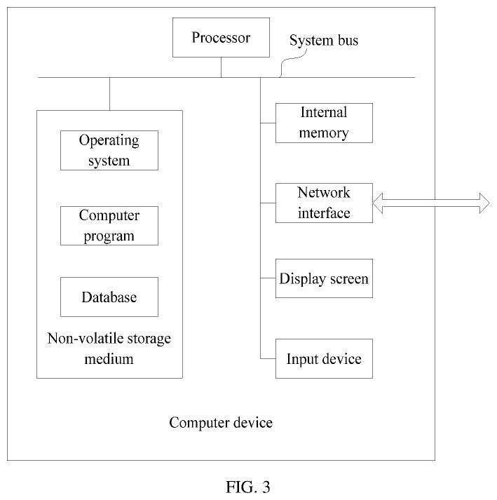

Referring to FIG. 3, some embodiments also provide a computer device, which may be a server, and an internal structure thereof may be as shown in the drawing. The computer device includes a processor, a memory, a network interface, and a database which are connected through a system bus. The processor designed by the computer is configured to provide computing and control capabilities. The memory of the computer device includes a non-volatile storage medium and an internal memory. The non-volatile storage medium stores an operating system, computer readable instructions, and a database. The internal memory provides an environment for the operations of the operating system and the computer readable instructions in the non-volatile storage medium. The database of the computer device is configured to store data used by a sentence distance mapping method based on machine learning. The network interface of the computer device is configured to communicate with an external terminal through a network. The computer readable instructions are executed by a processor to implement a sentence distance mapping method based on machine learning.

The foregoing processor executes the foregoing sentence distance mapping method based on machine learning, where the steps included in the method are in one-to-one correspondence to the steps of the sentence distance mapping method based on machine learning of the foregoing embodiments respectively, and are not described herein again.

Those skilled in the art can understand that the structure shown in the drawings is merely a block diagram of a partial structure related to the solution of the present disclosure, and does not constitute a limitation on the computer device to which the solution of the present disclosure is applied.

According to the computer device provided by some embodiments, acquired single-sentence speech information is converted into single-sentence text information, a word vector corresponding to each word in the preprocessed single-sentence text information is acquired by preprocessing, a distance between the single-sentence text information and a preset standard single sentence is calculated by using a preset algorithm by means of the word vector, and the distance is input into a preset function to obtain a score through mapping, which has more accurate and more visual technical effects.

Some embodiments also provide a non-volatile computer readable storage medium storing computer readable instructions. A sentence distance mapping method based on machine learning is implemented when the computer readable instructions are executed by a processor, where the steps included in the method are in one-to-one correspondence to the steps of the sentence distance mapping method based on machine learning of the foregoing embodiments respectively, and are not described herein again.

According to the non-volatile computer readable storage medium provided by some embodiments, acquired single-sentence speech information is converted into single-sentence text information, a word vector corresponding to each word in the preprocessed single-sentence text information is acquired by preprocessing, a distance between the single-sentence text information and a preset standard single sentence is calculated by using a preset algorithm by means of the word vector, and the distance is input into a preset function to obtain a score through mapping, which has more accurate and more visual technical effects.

Those of ordinary skill in the art can understand that all or some of processes for implementing the methods of the foregoing embodiments may be implemented through hardware related to computer programs. The computer programs may be stored in a non-volatile computer readable storage medium. The processes of the methods of the embodiments described above may be included when the computer programs are executed. Any reference to a memory, storage, a database, or other media provided by the present disclosure and used in embodiments may include a non-volatile memory and/or a volatile memory. The non-volatile memory may include a Read Only Memory (ROM), a Programmable ROM (PROM), an Electrically Programmable ROM (EPROM), an Electrically Erasable Programmable ROM (EEPROM), or a flash memory. The volatile memory may include a Random Access Memory (RAM) or an external cache memory. By way of illustration and not limitation, the RAM is available in a variety of formats, such as a Static RAM (SRAM), a Dynamic RAM (DRAM), a Synchronous DRAM (SDRAM), a Double Data Rate SDRAM (DDR SDRAM), an Enhanced SDRAM (ESDRAM), a Synchlink DRAM (SLDRAM), Memory Bus (Rambus) Direct RAM (RDRAM), a Direct Memory Bus Dynamic RAM (DRDRAM), and a Memory Bus Dynamic RAM (RDRAM).

It should be noted that the term “comprise”, “include”, or any other variant thereof is intended to encompass a non-exclusive inclusion, such that a process, device, article, or method that includes a series of elements includes not only those elements, but also other elements not explicitly listed, or elements that are inherent to such a process, device, article, or method. Without more restrictions, an element defined by the phrase “including a . . . ” does not exclude the presence of another same element in a process, device, article, or method that includes the element.

The above descriptions are only preferred embodiments of the present disclosure, and are not intended to limit the patent scope of the present disclosure. Any equivalent structure or equivalent process transformation performed using the specification and the accompanying drawings of the present disclosure may be directly or indirectly applied to other related technical fields and similarly falls within the patent protection scope of the present disclosure.

1. A sentence distance mapping method based on machine learning, comprising:
acquiring input single-sentence speech information;
converting the single-sentence speech information into single-sentence text information;
preprocessing the single-sentence text information, and querying a preset word vector library to obtain a word vector corresponding to each word in the preprocessed single-sentence text information, wherein the preprocessing comprises at least word segmentation processing;
calculating a distance between the single-sentence text information and a preset standard single sentence by using a preset algorithm based on the word vector corresponding to each word in the single-sentence text information, wherein the preset standard single sentence undergoes at least word segmentation processing; and
inputting the distance into a preset function to obtain a score through mapping, wherein the preset function is obtained by performing training on training data, and the training data comprises a training single sentence, a standard training single sentence, a distance between the training single sentence and the standard training single sentence, and a manual score on a similarity between the training single sentence and the standard training single sentence.

2. The sentence distance mapping method based on machine learning according to claim 1, wherein the step of preprocessing the single-sentence text information, and querying a preset word vector library to obtain a word vector corresponding to each word in the preprocessed single-sentence text information, wherein the preprocessing comprises at least word segmentation processing comprises:
performing word segmentation processing on the single-sentence text information to obtain a word sequence containing a plurality of words;
determining whether a synonym group exists in the word sequence by querying a preset synonym library; and
if a synonym group exists, replacing all words in the synonym group with any one in the synonym group.

3. The sentence distance mapping method based on machine learning according to claim 1, wherein the step of calculating a distance between the single-sentence text information and a preset standard single sentence by using a preset algorithm based on the word vector corresponding to each word in the single-sentence text information comprises:
adopting the following formula:
$$Distance ( I , R ) = \frac{{\sum }_{w ∈ I} min ( max ( α \times cos Dis ( w , R ) ) , I )}{\vert I \vert + \vert R \vert} + \frac{{\sum }_{w ∈ R} min ( max ( α \times cos Dis ( w , R ) ) , I )}{\vert I \vert + \vert R \vert}$$
to calculate the distance between the single-sentence text information and the preset standard single sentence, wherein Distance(I,R) denotes a distance between a single sentence I and a single sentence R; I denotes the single-sentence text information; R denotes the preset standard single sentence; |I| denotes the number of words with word vectors in the single-sentence text information; |R| denotes the number of words with word vectors in the preset standard single sentence; w denotes a word vector; α denotes an amplification coefficient for adjusting a cosine similarity between two word vectors; and max(α×Cos Dis(w,R)) denotes a calculated maximum value among cosine similarities between word vectors corresponding to all words in the single sentence R and the word vector w in the single sentence I.

4. The sentence distance mapping method based on machine learning according to claim 1, wherein the step of calculating a distance between the single-sentence text information and a preset standard single sentence by using a preset algorithm based on the word vector corresponding to each word in the single-sentence text information comprises:
adopting the following formula:
$$Distance ( I , R ) = {min}_{T \geq 0} {\sum }_{i = 1}^{m} {\sum }_{j = 1}^{m} {T}_{i j} c ( i , j ) , wherein {\sum }_{i = 1}^{m} {T}_{i j} = {d}_{j}^{′} ∀ j ∈ \{ 1 , … , n \} , {\sum }_{j = 1}^{n} {T}_{i j} = {d}_{i} ∀ i ∈ \{ 1 , … , m \}$$
to calculate the distance between the single-sentence text information and the preset standard single sentence; wherein Distance(I,R) denotes a distance between a single sentence I and a single sentence R; I denotes the single-sentence text information; R denotes the preset standard single sentence; Tij denotes an amount of weight transfer from an i-th word in the single sentence I to a j-th word in the single sentence R; di denotes a frequency of the i-th word in the single sentence I; d′ⱼ denotes a frequency of the j-th word in the single sentence R; c(i,j) denotes an Euclidean distance between the i-th word in the single sentence I and the j-th word in the single sentence R; m denotes the number of words with word vectors in the single sentence I; and n denotes the number of words with word vectors in the single sentence R.

5. The sentence distance mapping method based on machine learning according to claim 1, wherein the preset function is a unary quadratic function, and the step of obtaining the preset function by performing training on training data comprises:
establishing a unary quadratic function f(x)=ax²+bx+c, wherein x is an independent variable representing a sentence distance, and f(x) is a dependent variable representing a mapping score;
obtaining n pieces of sample data, and randomly dividing the sample data into n/3 groups, wherein each group has three pieces of sample data, the sample data comprises a training distance between a training single sentence and a standard single sentence, and a manual score result corresponding to the training distance, and n is a multiple of 3;
assigning the n/3 groups of data into the unary quadratic function to obtain values of n/3 groups of coefficients a, b, and c; and
performing a mean calculation on the values of the n/3 groups of coefficients a, b, and c to obtain final values of the coefficients a, b, and c.

6. The sentence distance mapping method based on machine learning according to claim 1, wherein the preset word vector library is obtained through training by using a word vector generating tool word2vec, and a method for obtaining the word vector library comprises:
performing word vector training on words in a preset corpus by using a Continuous Bag-of-Words (CBOW) model of the tool word2vec to obtain the preset word vector library, wherein the corpus is a word library for training word vectors.

7. The sentence distance mapping method based on machine learning according to claim 1, wherein before the step of calculating a distance between the single-sentence text information and a preset standard single sentence by using a preset algorithm based on the word vector corresponding to each word in the single-sentence text information, comprises:
calculating a similarity between the single-sentence text information and all standard single sentences in a standard single sentence library by using a reduplicative word similarity algorithm;
determining whether a standard single sentence having a similarity greater than a first threshold exists;
if a standard single sentence having a similarity greater than the first threshold exists, setting the standard single sentence having the similarity greater than the first threshold as the preset standard single sentence.

8. A computer device, comprising a memory storing computer readable instructions and a processor, wherein a sentence distance mapping method based on machine learning is implemented when the processor executes the computer readable instructions, and the sentence distance mapping method based on machine learning comprises:
acquiring input single-sentence speech information;
converting the single-sentence speech information into single-sentence text information;
preprocessing the single-sentence text information, and querying a preset word vector library to obtain a word vector corresponding to each word in the preprocessed single-sentence text information, wherein the preprocessing comprises at least word segmentation processing;
calculating a distance between the single-sentence text information and a preset standard single sentence by using a preset algorithm based on the word vector corresponding to each word in the single-sentence text information, wherein the preset standard single sentence undergoes at least word segmentation processing; and
inputting the distance into a preset function to obtain a score through mapping, wherein the preset function is obtained by performing training on training data, and the training data comprises a training single sentence, a standard training single sentence, a distance between the training single sentence and the standard training single sentence, and a manual score on a similarity between the training single sentence and the standard training single sentence.

9. The computer device according to claim 8, wherein the step of preprocessing the single-sentence text information, and querying a preset word vector library to obtain a word vector corresponding to each word in the preprocessed single-sentence text information, wherein the preprocessing comprises at least word segmentation processing comprises:
performing word segmentation processing on the single-sentence text information to obtain a word sequence containing a plurality of words;
determining whether a synonym group exists in the word sequence by querying a preset synonym library; and
if a synonym group exists, replacing all words in the synonym group with any one in the synonym group.

10. The computer device according to claim 8, wherein the step of calculating a distance between the single-sentence text information and a preset standard single sentence by using a preset algorithm based on the word vector corresponding to each word in the single-sentence text information comprises:
adopting the following formula:
$$Distance ( I , R ) = \underline{\frac{{\sum }_{w ∈ I} min ( max ( α \times cos Dis ( w , R ) ) , I )}{\vert I \vert + \vert R \vert} + \frac{{\sum }_{w ∈ R} min ( max ( α \times cos Dis ( w , R ) ) , I )}{\vert I \vert + \vert R \vert}}$$
to calculate the distance between the single-sentence text information and the preset standard single sentence, wherein Distance(I,R) denotes a distance between a single sentence I and a single sentence R; I denotes the single-sentence text information; R denotes the preset standard single sentence; |I| denotes the number of words with word vectors in the single-sentence text information; |R| denotes the number of words with word vectors in the preset standard single sentence; w denotes a word vector; α denotes an amplification coefficient for adjusting a cosine similarity between two word vectors; and max(α×Cos Dis(w,R)) denotes a calculated maximum value among cosine similarities between word vectors corresponding to all words in the single sentence R and the word vector w in the single sentence I.

11. The computer device according to claim 8, wherein the step of calculating a distance between the single-sentence text information and a preset standard single sentence by using a preset algorithm based on the word vector corresponding to each word in the single-sentence text information comprises:
adopting the following formula:
$$Distance ( I , R ) = {min}_{T \geq 0} {\sum }_{i = 1}^{m} {\sum }_{j = 1}^{m} {T}_{i j} c ( i , j ) , \underline{wherein {\sum }_{i = 1}^{m} {T}_{i j} = {d}_{j}^{′} ∀ j ∈ \{ 1 , … , n \} , {\sum }_{j = 1}^{n} {T}_{i j} = {d}_{i} ∀ i ∈ \{ 1 , … , m \}}$$
to calculate the distance between the single-sentence text information and the preset standard single sentence; wherein Distance(I,R) denotes a distance between a single sentence I and a single sentence R; I denotes the single-sentence text information; R denotes the preset standard single sentence; Tij denotes an amount of weight transfer from an i-th word in the single sentence I to a j-th word in the single sentence R; di denotes a frequency of the i-th word in the single sentence I; d′ⱼ denotes a frequency of the j-th word in the single sentence R; c(i,j) denotes an Euclidean distance between the i-th word in the single sentence I and the j-th word in the single sentence R; m denotes the number of words with word vectors in the single sentence I; and n denotes the number of words with word vectors in the single sentence R.

12. The computer device according to claim 8, wherein the preset function is a unary quadratic function, and the step of obtaining the preset function by performing training on training data comprises:
establishing a unary quadratic function f(x)=ax²+bx+c, wherein x is an independent variable representing a sentence distance, and f(x) is a dependent variable representing a mapping score;
obtaining n pieces of sample data, and randomly dividing the sample data into n/3 groups, wherein each group has three pieces of sample data, the sample data comprises a training distance between a training single sentence and a standard single sentence, and a manual score result corresponding to the training distance, and n is a multiple of 3;
assigning the n/3 groups of data into the unary quadratic function to obtain values of n/3 groups of coefficients a, b, and c; and
performing a mean calculation on the values of the n/3 groups of coefficients a, b, and c to obtain final values of the coefficients a, b, and c.

13. The computer device according to claim 8, wherein the preset word vector library is obtained through training by using a word vector generating tool word2vec, and a method for obtaining the word vector library comprises:
performing word vector training on words in a preset corpus by using a Continuous Bag-of-Words (CBOW) model of the tool word2vec to obtain the preset word vector library, wherein the corpus is a word library for training word vectors.

14. The computer device according to claim 8, wherein before the step of calculating a distance between the single-sentence text information and a preset standard single sentence by using a preset algorithm based on the word vector corresponding to each word in the single-sentence text information, comprises:
calculating a similarity between the single-sentence text information and all standard single sentences in a standard single sentence library by using a reduplicative word similarity algorithm;
determining whether a standard single sentence having a similarity greater than a first threshold exists;
if a standard single sentence having a similarity greater than the first threshold exists, setting the standard single sentence having the similarity greater than the first threshold as the preset standard single sentence.

15. A non-volatile computer readable storage medium storing computer readable instructions, wherein a sentence distance mapping method based on machine learning is implemented when the computer readable instructions are executed by a processor, and the sentence distance mapping method based on machine learning comprises:
acquiring input single-sentence speech information;
converting the single-sentence speech information into single-sentence text information;
preprocessing the single-sentence text information, and querying a preset word vector library to obtain a word vector corresponding to each word in the preprocessed single-sentence text information, wherein the preprocessing comprises at least word segmentation processing;
calculating a distance between the single-sentence text information and a preset standard single sentence by using a preset algorithm based on the word vector corresponding to each word in the single-sentence text information, wherein the preset standard single sentence undergoes at least word segmentation processing; and
inputting the distance into a preset function to obtain a score through mapping, wherein the preset function is obtained by performing training on training data, and the training data comprises a training single sentence, a standard training single sentence, a distance between the training single sentence and the standard training single sentence, and a manual score on a similarity between the training single sentence and the standard training single sentence.

16. The non-volatile computer readable storage medium according to claim 15, wherein the step of preprocessing the single-sentence text information, and querying a preset word vector library to obtain a word vector corresponding to each word in the preprocessed single-sentence text information, wherein the preprocessing comprises at least word segmentation processing comprises:
performing word segmentation processing on the single-sentence text information to obtain a word sequence containing a plurality of words;
determining whether a synonym group exists in the word sequence by querying a preset synonym library; and
if a synonym group exists, replacing all words in the synonym group with any one in the synonym group.

17. The non-volatile computer readable storage medium according to claim 15, wherein the step of calculating a distance between the single-sentence text information and a preset standard single sentence by using a preset algorithm based on the word vector corresponding to each word in the single-sentence text information comprises:
adopting the following formula:
$$Distance ( I , R ) = \underline{\frac{{\sum }_{w ∈ I} min ( max ( α \times cos Dis ( w , R ) ) , I )}{\vert I \vert + \vert R \vert} + \frac{{\sum }_{w ∈ R} min ( max ( α \times cos Dis ( w , R ) ) , I )}{\vert I \vert + \vert R \vert}}$$
to calculate the distance between the single-sentence text information and the preset standard single sentence, wherein Distance(I,R) denotes a distance between a single sentence I and a single sentence R; I denotes the single-sentence text information; R denotes the preset standard single sentence; |I| denotes the number of words with word vectors in the single-sentence text information; |R denotes the number of words with word vectors in the preset standard single sentence; w denotes a word vector; α denotes an amplification coefficient for adjusting a cosine similarity between two word vectors; and max(α×Cos Dis(w,R)) denotes a calculated maximum value among cosine similarities between word vectors corresponding to all words in the single sentence R and the word vector w in the single sentence I.

18. The non-volatile computer readable storage medium according to claim 15, wherein the step of calculating a distance between the single-sentence text information and a preset standard single sentence by using a preset algorithm based on the word vector corresponding to each word in the single-sentence text information comprises:
adopting the following formula:
$$Distance ( I , R ) = {min}_{T \geq 0} {\sum }_{i = 1}^{m} {\sum }_{j = 1}^{m} {T}_{i j} c ( i , j ) , \underline{wherein {\sum }_{i = 1}^{m} {T}_{i j} = {d}_{j}^{′} ∀ j ∈ \{ 1 , … , n \} , {\sum }_{j = 1}^{n} {T}_{i j} = {d}_{i} ∀ i ∈ \{ 1 , … , m \}}$$
to calculate the distance between the single-sentence text information and the preset standard single sentence; wherein Distance(I,R) denotes a distance between a single sentence I and a single sentence R; I denotes the single-sentence text information; R denotes the preset standard single sentence; Tij denotes an amount of weight transfer from an i-th word in the single sentence I to a j-th word in the single sentence R; di denotes a frequency of the i-th word in the single sentence I; d′ⱼ denotes a frequency of the j-th word in the single sentence R; c(i,j) denotes an Euclidean distance between the i-th word in the single sentence I and the j-th word in the single sentence R; m denotes the number of words with word vectors in the single sentence I; and n denotes the number of words with word vectors in the single sentence R.

19. The non-volatile computer readable storage medium according to claim 15, wherein the preset function is a unary quadratic function, and the step of obtaining the preset function by performing training on training data comprises:
establishing a unary quadratic function f(x)=ax²+bx+c, wherein x is an independent variable representing a sentence distance, and f(x) is a dependent variable representing a mapping score;
obtaining n pieces of sample data, and randomly dividing the sample data into n/3 groups, wherein each group has three pieces of sample data, the sample data comprises a training distance between a training single sentence and a standard single sentence, and a manual score result corresponding to the training distance, and n is a multiple of 3;
assigning the n/3 groups of data into the unary quadratic function to obtain values of n/3 groups of coefficients a, b, and c; and
performing a mean calculation on the values of the n/3 groups of coefficients a, b, and c to obtain final values of the coefficients a, b, and c.

20. The non-volatile computer readable storage medium according to claim 15, wherein the preset word vector library is obtained through training by using a word vector generating tool word2vec, and a method for obtaining the word vector library comprises:
performing word vector training on words in a preset corpus by using a Continuous Bag-of-Words (CBOW) model of the tool word2vec to obtain the preset word vector library, wherein the corpus is a word library for training word vectors.
